(19) United States
(12) Patent Application Publication
(10) Pub. No.: US 2011/0007751 A1
(43) Pub. Date: Jan. 13, 2011

(54) TRANSPORT STREAM RECORDING AND TRANSMISSION METHOD AND DEVICE THEREOF

(75) Inventor: Kouichi TSUTSUMI, Osaka (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/884,956

(22) Filed: Sep. 17, 2010

Related U.S. Application Data
(63) Continuation-in-part of application No. PCT/JP2009/001634, filed on Apr. 8, 2009.

(30) Foreign Application Priority Data
Jun. 4, 2008 (JP) 2008-146623

(51) Int. Cl. H04L 12/54

(52) U.S. Cl. 370/428

(57) ABSTRACT

A partial transport stream (TS) is temporarily recorded in a recording medium before being transmitted to a network. Here, when the partial TS is generated, null packets (invalid packets) are inserted into some of positions of packets determined not to be recorded, at a predetermined rate, and the resultant partial TS is recorded into the recording medium. When transmission is performed, the null packets previously inserted during recording are each replaced with a packet which contains information which is required during transmission, e.g., a program-specific information/service information (PSI/SI) packet. As a result, the load of packet inserting process during transmission can be reduced.

### CROSS-REFERENCE TO RELATED APPLICATIONS

This is a continuation of PCT International Application PCT/JP2009/001634 filed on Apr. 8, 2009, which claims priority to Japanese Patent Application No. 2008-146623 filed on Jun. 4, 2008. The disclosures of these applications including the specifications, the drawings, and the claims are hereby incorporated by reference in their entirety.

### BACKGROUND

The present disclosure relates to transport stream recording and transmission methods for temporarily recording a received transport stream (TS) in a recording medium, and transmitting the recorded TS to an apparatus connected to a network, and devices employing the methods.

By utilizing MPEG2 transport stream (MPEG2-TS), a plurality of pieces of multimedia data can be multiplexed and transmitted. For example, in digital broadcasting, a plurality of services are multiplexed and transmitted by utilizing MPEG2-TS.

On the other hand, in an apparatus which records or distributes a received MPEG2-TS, only data relating to a specific service is extracted from the received MPEG2-TS in order to reduce the recording or distribution band to generate a partial TS, which is then recorded or distributed. Note that the received MPEG2-TS is processed to generate and distribute the partial TS to a network without via a recording medium in real time (see Japanese Patent Publication No. H11-239186).

### SUMMARY

In recent years, however, because inexpensive recording media having a larger and larger recording capacity, such as hard disks and the like, have been available, there have been an increasing number of devices in which a partial TS is generated from an input MPEG2-TS and temporarily recorded in such a recording medium, and is read from the recording medium and transmitted to an apparatus connected to a network in response to a request from the apparatus.

In the devices, when a partial TS read from the recording medium is transmitted to an apparatus connected to a network, it may be necessary to additionally insert into the partial TS a TS packet which contains information required during transmission.

In this case, it is necessary to read system time information contained in a TS or time stamp information added to each transport packet to search for a packet insertion position which does not require correction of the information and insert an additional packet into the position, or correct the time information after inserting the additional packet.

The additional packet inserting process during transmission is often performed by a processor which can access a buffer memory in which the partial TS read from the recording medium is temporarily stored. However, the frequency of the access to the buffer memory is high, resulting in a large processing load on the processor, which is a problem. The additional packet inserting process may be performed by dedicated hardware, but in this case, the circuit area increases, resulting in an increase in cost.

Therefore, the detailed description describes implementations of a small-scale circuit which efficiently performs a process of inserting an additional TS packet containing information required during transmission into a partial TS when the partial TS is temporarily recorded in a recording medium before being transmitted into an apparatus connected to a network.

An example TS recording and transmission method according to the present disclosure includes selecting a TS packet relating to a predetermined service to be recorded based on a packet identifier (PID) contained in an input TS, and removing a TS packet not to be recorded, inserting an invalid packet (e.g., a null packet) into a position of the TS packet not to be recorded at a predetermined rate to generate a record partial TS, and recording the record partial TS into the recording medium. The method further includes, when transmitting the TS to a network, reading the record partial TS from the recording medium and detecting the invalid packet inserted during recording, replacing the detected invalid packet with a packet containing information required during transmission to the network to generate a transmit TS, and transmitting the transmit TS to the network.

An example TS recording and transmission device according to the present disclosure includes a PID filter configured to select a TS packet relating to a predetermined service to be recorded based on a PID in an input TS, a packet replacer configured to replace a TS packet which the PID filter has determined is not to be recorded with a packet containing information required during recording which is an invalid packet or a program-specific information/service information (PSI/SI) packet, a recording medium configured to record the partial TS output from the packet replacer, and a network interface configured to read the partial TS recorded in the recording medium and transmit the partial TS to a network. Here, PSI means program specific information, and SI means service information indicating a program sequence or the like.

In the example TS recording and transmission method of the present disclosure, when a partial TS is generated during recording, invalid packets are inserted into some of positions of packets determined not to be recorded, at a predetermined rate, and the resultant partial TS is recorded into the recording medium. When transmission is performed, the null packets previously inserted during recording are each replaced with a packet which contains information which is required during transmission. As a result, the load of a packet inserting process during transmission can be reduced.

In the example TS recording and transmission device of the present disclosure, when a partial TS is generated, invalid packets are inserted into some of positions of packets which the PID filter has determined are not to be recorded, at a predetermined rate, whereby the invalid packets can be multiplexed with the record partial TS using a small-scale circuit.

### BRIEF DESCRIPTION OF THE DRAWINGS

FIG. 1 is a block diagram showing a specific example transport stream (TS) recording and transmission device according to the present disclosure.

FIG. 2 is a flowchart showing an example TS recording and transmission method according to the present disclosure.

FIG. 3 is a time chart showing an example TS processing step according to the present disclosure.

### DETAILED DESCRIPTION

Embodiments of the present disclosure will be described hereinafter with reference to the accompanying drawings.

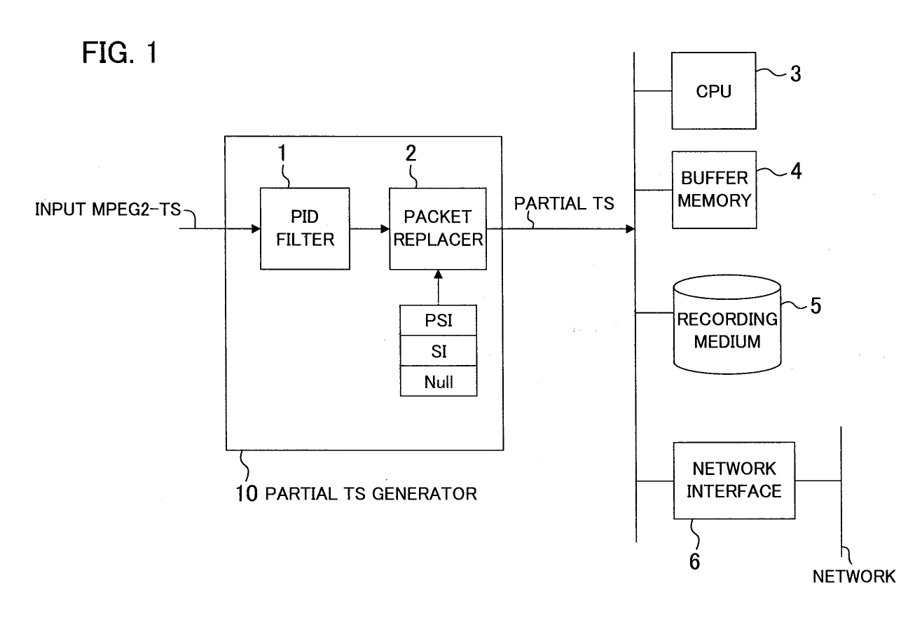

FIG. 1 is a block diagram showing a specific example TS recording and transmission device according to the present disclosure. The device of FIG. 1 includes a partial TS generator 10 which generates a record partial TS from an input TS, a recording medium 5 which records the partial TS output from the partial TS generator 10, a buffer memory 4 which reads data from the recording medium 5 and temporarily holds the data, a CPU 3 which adds a packet containing information which is required during transmission to the partial TS or processes the partial TS into a stream which complies with a network transmission protocol, via the buffer memory 4, and a network interface 6 which reads the stream from the buffer memory 4 and transmits the stream to a network. The partial TS generator 10 includes a PID filter 1 which selects a packet to be recorded, and a packet replacer 2 which replaces a TS packet which the PID filter 1 has determined is not to be recorded with a PSI/SI packet or a null packet (invalid packet).

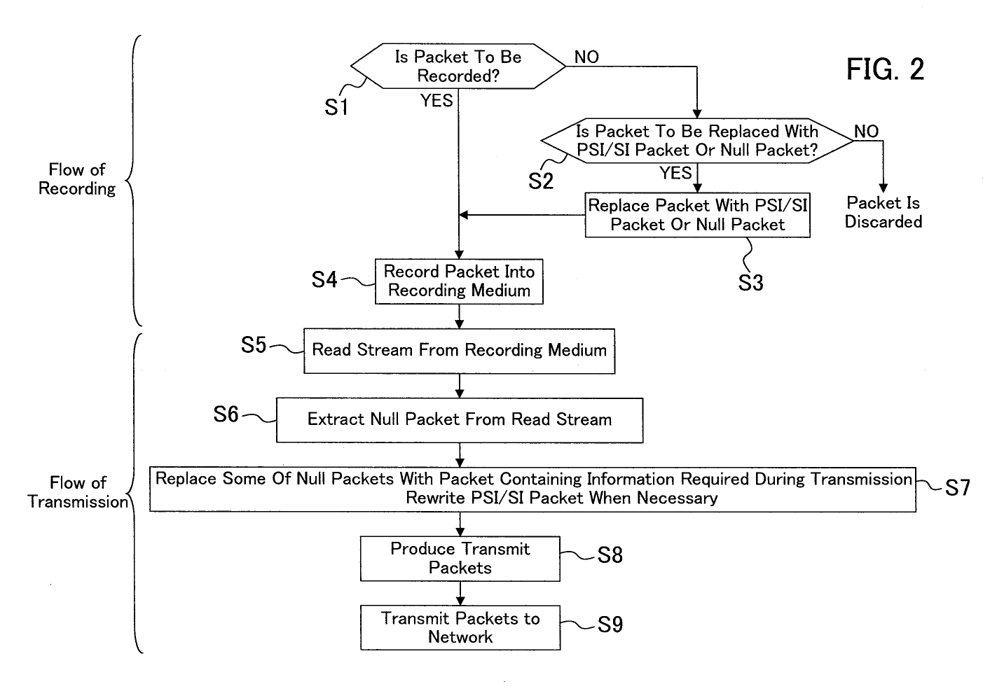

FIG. 2 is a flowchart showing a procedure of recording and transmitting a transport stream. In step S1, the PID filter 1 determines whether a transport packet is to be recorded with reference to a PID contained in the header of the transport packet. When the PID filter 1 determines that the transport packet is to be recorded, the partial TS generator 10 outputs the transport packet, which is then recorded into the recording medium 5. In step S2, the packet replacer 2 makes a decision whether to replace the transport packet which the PID filter 1 has determined is not to be recorded with a PSI/SI packet or a null packet which is generated for recording. In this case, the packet replacer 2 makes a decision to replace the transport packet with a PSI/SI packet or a null packet at a predetermined rate. While a packet which is not to be replaced is discarded, the replaced packet is output from the partial TS generator 10 and is then recorded into the recording medium 5 (steps S3 and S4).

Note that the packet replacer 2 may notify the CPU 3 of information about a position on the stream of the replaced packet so that the packet replacement position information are recorded into the recording medium 5, together with the record partial TS. Moreover, the packet replacer 2 may insert a null packet into a space at a boundary of a logic data block of a PSI/SI packet, i.e., a data block indicated by payload_unit_start_indicator of the TS header.

Step S5 and the subsequent steps are involved with transmission. In step S5, the partial TS read from the recording medium 5 is temporarily stored in the buffer memory 4. When the packet replacement position information is recorded in the recording medium 5, the information is also stored in the buffer memory 4.

In step S6, the CPU 3 detects the null packet which has been inserted during recording, from the partial TS stored in the buffer memory 4. Note that the position of the null packet may be detected with reference to the packet replacement position information.

In step S7, the CPU 3 generates a packet which contains information which is required during transmission, and replaces the null packet detected in step S6 with the packet which contains information which is required during transmission (e.g., a PSI/SI packet). In this case, null packets to be replaced are determined so that each of the packets which contains information which is required during transmission is inserted at a predetermined rate. Note that when the PSI/SI packet inserted during recording needs to be changed during transmission, the PSI/SI packet is rewritten.

The CPU 3 and the network interface 6 process a stream in accordance with a network transmission protocol (step S8). Finally, the network interface 6 transmits the stream to a connected network (step S9).

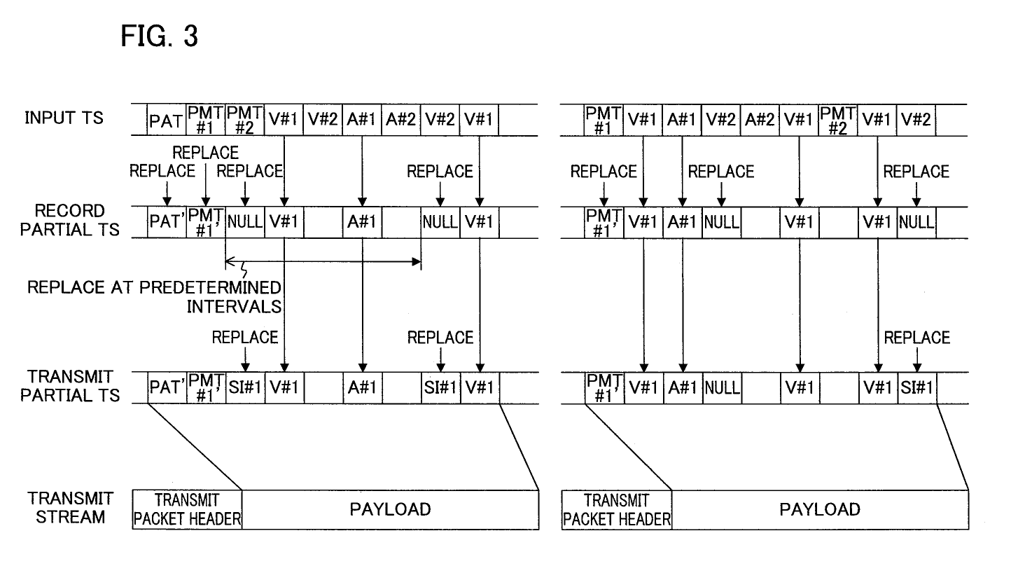

The aforementioned steps will be described in greater detail with reference to FIG. 3. FIG. 3 is a diagram showing steps of processing a stream in which an input TS is converted into a partial TS, which is then temporarily recorded before being transmitted to a network.

The input TS includes a plurality of services (services #1 and #2). The service #1 contains packets which are a PMT #1, video (V #1), audio (A #1), and the like, and the service #2 contains packets which are a PMT #2, video (V #2), audio (A #2), and the like, where PMT means a program map table. In FIG. 3, PAT means a program association table.

Here, when only the service #1 is to be recorded, packets other than the packets of the service #1 to be recorded are removed after PID filtering, and PSI/SI packets or null packets generated for the purpose of recording are inserted into some of positions from which the packets have been removed at predetermined intervals. When transmission is performed, null packets are each replaced with a packet which contains information which is required during transmission (e.g., a PSI/SI packet) at predetermined intervals. Moreover, the PSI/SI packets are updated when necessary. The generated stream is processed in accordance with a network protocol (e.g., addition of a transmission packet header) before being transmitted to a network.

As described above, in the TS recording and transmission method according to the embodiment of the present disclosure and the device employing the method, when the packet replacer 2 generates a partial TS which is to be recorded, null packets (invalid packets) are inserted into some of the positions of packets which the PID filter 1 has determined are not to be recorded at a predetermined rate before the partial TS is recorded into the recording medium 5. When transmission is performed, by inserting packets which contain information which is required during transmission into the positions of the null packets inserted during recording, the load of the packet inserting process during transmission can be reduced.

As described above, in the TS recording and transmission method of the present disclosure and the device employing the method, the load of the packet inserting process during transmission can be reduced. Therefore, the present disclosure is useful for recording and reproduction devices for digital broadcasting and the like.

What is claimed is:

1. A method for temporarily recording a transport stream (TS) in a recording medium and transmitting the recorded TS to a network, the method comprising:
a first step of selecting a TS packet relating to a predetermined service to be recorded based on a packet identifier (PID) contained in the input TS, and removing a TS packet not to be recorded;
a second step of inserting an invalid packet into a position of the TS packet not to be recorded at a predetermined rate to generate a record partial TS;
a third step of outputting and recording the record partial TS into the recording medium;
a fourth step of reading the record partial TS from the recording medium and detecting the invalid packet inserted in the second step;
a fifth step of replacing the detected invalid packet with a packet containing information required during transmission to the network to generate a transmit TS; and
a sixth step of transmitting the transmit TS to the network.

2. The method of claim 1, wherein
the second step includes a step of generating and inserting a program-specific information/service information (PSI/SI) packet relating to the predetermined service to be recorded.

3. The method of claim 1, wherein
the second step includes a step of determining information about a position of the inserted invalid packet,
the third step includes a step of recording the invalid packet position information into the recording medium, together with the record partial TS, and
the fourth step includes a step of, when reading out the record partial TS, reading the invalid packet position information from the recording medium, and detecting the position of the inserted invalid packet from the invalid packet position information.

4. A transport stream recording and transmission device comprising:
a PID filter configured to select a transport stream (TS) packet relating to a predetermined service to be recorded based on a packet identifier (PID) in an input TS;
a packet replacer configured to replace a TS packet which the PID filter has determined is not to be recorded with a packet containing information required during recording which is an invalid packet or a program-specific information/service information (PSI/SI) packet;
a recording medium configured to record the partial TS output from the packet replacer; and
a network interface configured to read the partial TS recorded in the recording medium and transmit the partial TS to a network.

5. The transport stream recording and transmission device of claim 4, wherein
the packet replacer determines an insertion interval of the invalid packet or the PSI/SI packet so that the invalid packet or the PSI/SI packet is inserted at a predetermined rate.

6. The transport stream recording and transmission device of claim 4, wherein
the packet replacer inserts the invalid packet into a boundary of a logic data block of the PSI/SI packet.

7. The transport stream recording and transmission device of claim 4, wherein
the packet replacer, when inserting the invalid packet or the PSI/SI packet, outputs information about a position of the inserted packet.
